(19) United States
(12) Patent Application Publication
(10) Pub. No.: US 2015/0153773 A1
(43) Pub. Date: Jun. 4, 2015

(54) DOCKING STATION

(71) Applicants: Yuan-Shie Chang, Taipei City (TW); Chia-Hung Ou, Taipei City (TW); Chia-Chi Ou, Taipei City (TW)

(72) Inventors: Yuan-Shie Chang, Taipei City (TW); Chia-Hung Ou, Taipei City (TW); Chia-Chi Ou, Taipei City (TW)

(73) Assignee: COMPAL ELECTRONICS, INC., Taipei City (TW)

(21) Appl. No.: 14/549,563

(22) Filed: Nov. 21, 2014

(30) Foreign Application Priority Data
Nov. 29, 2013 (TW) 102143806

(51) Int. Cl. G06F 1/16; H04M 1/725

(52) U.S. Cl. CPC G06F 1/1632; H04M 1/725

(57) ABSTRACT

A docking station that includes a first casing, a second casing, and a signal transmitting/receiving unit is provided. The first casing has a first antenna. The second casing is connected to the first casing and has a cavity, and the cavity is adapted to hold an electronic device. The signal transmitting/receiving unit is disposed at a bottom of the cavity and electrically connected to the first antenna. When the electronic device is held in the cavity, the electronic device receives and transmits wireless signals by the first antenna through the signal transmitting/receiving unit.

### CROSS-REFERENCE TO RELATED APPLICATION

This application claims the priority benefit of Taiwan application serial no. 102143806, filed on Nov. 29, 2013. The entirety of the above-mentioned patent application is hereby incorporated by reference herein and made a part of this specification.

### BACKGROUND OF THE INVENTION

1. Field of the Invention

The invention relates to a docking station and more particularly to a docking station equipped with an antenna.

2. Description of Related Art

With the progress of science and technology, mass communications have been gradually changed to wireless communications. For instance, wireless communications are applicable to handheld electronic devices including smart phones and tablet PCs capable of performing the wireless Internet access function.

The smart phones are often characterized by small volume and light weight, so that they can be carried around with ease. Since the small smart phones are not able to provide users with large display screens and operating interfaces, docking stations that may be employed together with the smart phones have been developed. The users may set the smart phones onto the docking stations whereby the users may be provided with large display screens and operating interfaces (e.g., keyboards). However, when the smart phones are configured onto the docking stations, the antennas of the smart phones may be covered by the casings of docking stations, such that the signal receiving and transmitting capabilities of the smart phones may be reduced. Accordingly, how to guarantee the satisfactory signal receiving and transmitting capabilities of the smart phones configured on the docking stations is crucial to the design of the docking stations.

### SUMMARY OF THE INVENTION

The invention is directed to a docking station that allows an electronic device configured onto the docking station to have favorable signal receiving and transmitting capabilities.

In an embodiment of the invention, a docking station that includes a first casing, a second casing, and a signal transmitting/receiving unit is provided. The first casing has a first antenna. The second casing is connected to the first casing and has a cavity, and the cavity is adapted to hold an electronic device. The signal transmitting/receiving unit is disposed at a bottom of the cavity and electrically connected to the first antenna. When the electronic device is held in the cavity, the electronic device receives and transmits wireless signals by the first antenna through the signal transmitting/receiving unit.

According to an embodiment of the invention, the docking station further includes a display screen and a keyboard. The display screen is disposed at the first casing, and the keyboard is disposed at the second casing.

According to an embodiment of the invention, the docking station further includes a hinge, and the first casing is pivoted to the second casing through the hinge.

According to an embodiment of the invention, the signal transmitting/receiving unit is a metal sheet that is shaped as an antenna.

According to an embodiment of the invention, the signal transmitting/receiving unit is a circuit board, and the circuit board has a metal layer that is shaped as an antenna.

According to an embodiment of the invention, the signal transmitting/receiving unit is covered by the second casing.

According to an embodiment of the invention, the signal transmitting/receiving unit is exposed by the second casing.

According to an embodiment of the invention, the signal transmitting/receiving unit is electrically connected to the first antenna through a signal line.

According to an embodiment of the invention, the docking station includes a signal booster located between the signal transmitting/receiving unit and the first antenna and connected to the signal transmitting/receiving unit and the first antenna through a signal line.

According to an embodiment of the invention, the electronic device has a second antenna, and when the electronic device is held in the cavity, the signal transmitting/receiving unit and the second antenna are coupled to each other.

According to an embodiment of the invention, when the electronic device moves away from the cavity, the first antenna neither receives nor transmits the wireless signals.

In light of the foregoing, the docking station described herein has the signal transmitting/receiving unit at the bottom of the cavity of the second casing, and the first casing of the docking station has the first antenna. The signal transmitting/receiving unit is electrically connected to the first antenna. Accordingly, if the user places the electronic device in the cavity of the second casing, the signal transmitting/receiving unit at the bottom of the cavity is adjacent to the electronic device, such that the electronic device is capable of receiving and transmitting the wireless signals by the first antenna of the docking station through the signal transmitting/receiving unit. As a result, the signal receiving and transmitting capabilities of the electronic device may be improved.

In order to make the aforementioned and other features and advantages of the invention comprehensible, embodiments accompanied with figures are described in detail below.

### BRIEF DESCRIPTION OF THE DRAWINGS

FIG. 1 is a three-dimensional diagram illustrating a docking station according to an embodiment of the invention.

FIG. 2 is a schematic diagram illustrating that the docking station depicted in FIG. 1 is separated from an electronic device.

FIG. 3 is a schematic diagram illustrating that the electronic device depicted in FIG. 2 is configured at a docking station.

FIG. 4 is a partial cross-sectional diagram illustrating the docking station and the electronic device depicted in FIG. 3.

FIG. 5 illustrates the way in which the electronic device depicted in FIG. 2 transmits and receives wireless signals.

FIG. 6 illustrates the way in which the electronic device depicted in FIG. 3 transmits and receives wireless signals.

FIG. 7 is a partial cross-sectional diagram illustrating a docking station and an electronic device according to another embodiment of the invention.

FIG. 8 is a schematic diagram illustrating a signal booster between the first antenna and the signal transmitting/receiving unit depicted in FIG. 1.

### DETAILED DESCRIPTION OF DISCLOSED EMBODIMENTS

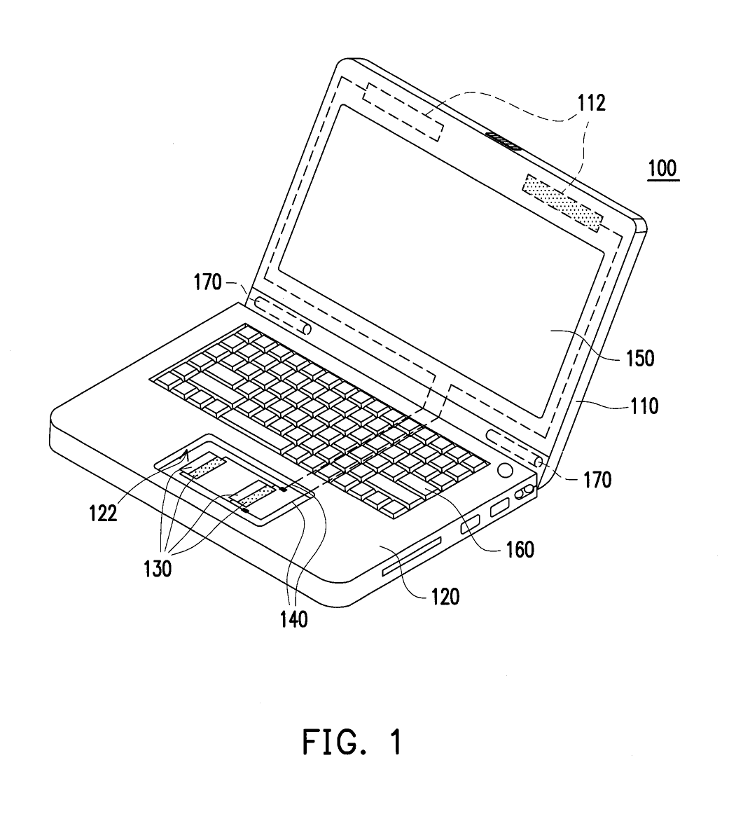

FIG. 1 is a three-dimensional diagram illustrating a docking station according to an embodiment of the invention. With reference to FIG. 1, the docking station 100 described in the present embodiment includes a first casing 110, a second casing 120, and at least one signal transmitting/receiving unit 130. Note that multiple signal transmitting/receiving units 130 are depicted in FIG. 1. The first casing 110 has at least one first antenna 112, and multiple first antennas 112 are depicted in FIG. 1. The second casing 120 is connected to the first casing 110 and has a cavity 122. The signal transmitting/receiving unit 130 is disposed at a bottom of the cavity 122 and electrically connected to the first antenna 112.

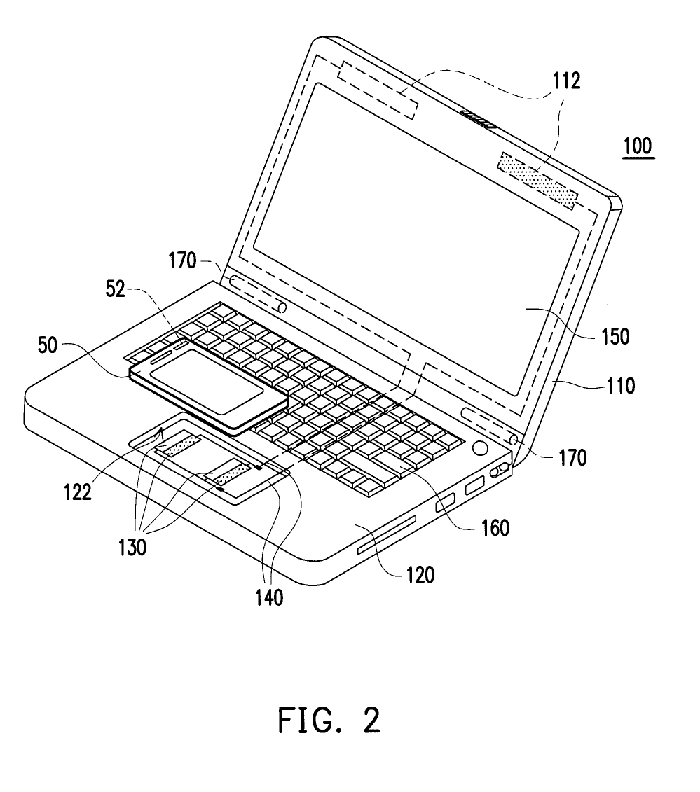

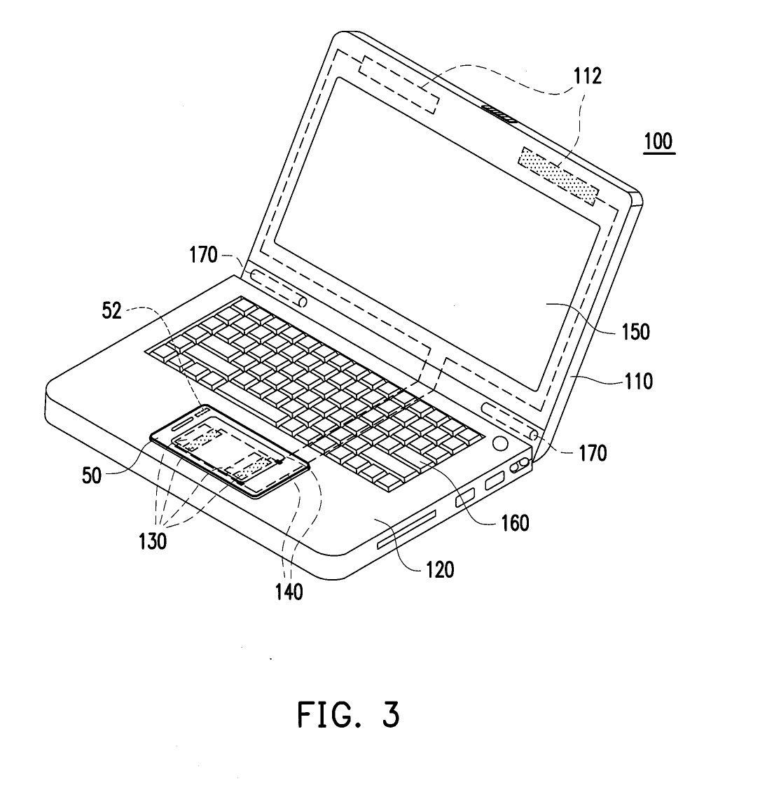

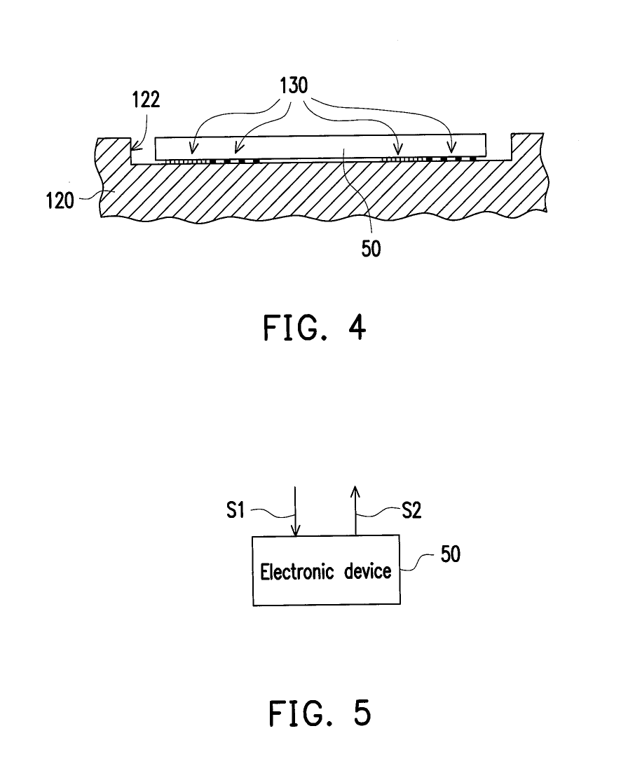

FIG. 2 is a schematic diagram illustrating that the docking station depicted in FIG. 1 is separated from an electronic device. FIG. 3 is a schematic diagram illustrating that the electronic device depicted in FIG. 2 is configured at a docking station. FIG. 4 is a partial cross-sectional diagram illustrating the docking station and the electronic device depicted in FIG. 3. With reference to FIG. 2 to FIG. 4, in the present embodiment, the cavity 122 of the second casing 120 is adapted to hold an electronic device 50, such that the electronic device 50 is adjacent to the signal transmitting/receiving unit 130. The electronic device 50 is a smart phone or any other handheld electronic device capable of receiving and transmitting wireless signals, for instance.

According to the above configuration, the docking station 100 described herein has the signal transmitting/receiving unit 130 at the bottom of the cavity 122 of the second casing 120, and the first casing 110 of the docking station 100 has the first antenna 112. The signal transmitting/receiving unit 130 is electrically connected to the first antenna 112. Accordingly, if a user places the electronic device 50 in the cavity 122 of the second casing 120, the signal transmitting/receiving unit 130 at the bottom of the cavity 122 is adjacent to the electronic device 50, such that the electronic device 50 is capable of receiving and transmitting the wireless signals by the first antenna 112 of the docking station 100 through the signal transmitting/receiving unit 130. As a result, the signal receiving and transmitting capabilities of the electronic device 50 may be improved.

The electronic device 50 described in the present embodiment receives and transmits signals by way of coupling through the signal transmitting/receiving unit 130, for instance. Specifically, the electronic device 50 has a second antenna 52. When the electronic device 50 is held in the cavity 122 of the second casing 120, the signal transmitting/receiving unit 130 and the second antenna 52 of the electronic device 50 are electrically connected through coupling. The second antenna 52 of the electronic device 50 receives signals from the signal transmitting/receiving unit 130 or transmits signals to the signal transmitting/receiving unit 130 through wireless connection. The position of the second antenna 52 shown in FIG. 2 and FIG. 3 is merely schematic; in other embodiments of the invention, the second antenna 52 may be configured at any other appropriate position in the electronic device 50.

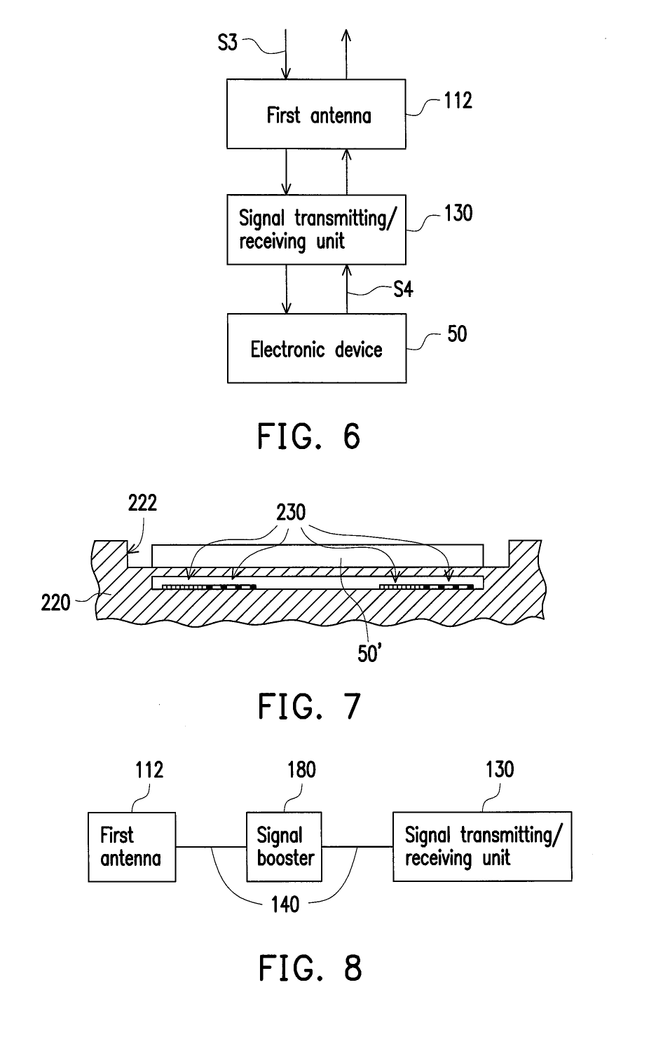

FIG. 5 illustrates the way in which the electronic device depicted in FIG. 2 transmits and receives wireless signals. As shown in FIG. 2, if the electronic device 50 moves away from the cavity 122 of the second casing 120, the first antenna 112 of the docking station 100 may continue to receive the wireless signals; however, since the electronic device 50 has left the second casing 120, no component in the second casing 120 is capable of processing the received wireless signals. The electronic device 50 receives and transmits signals in the way shown in FIG. 5. According to the way to receive and transmit the signals, as shown in FIG. 5, the wireless signal Si from the surroundings may be directly received by the electronic device 50 instead of being received by the first antenna 112 through the signal transmitting/receiving unit 130. In addition, the wireless signal S2 from the electronic device 50 is directly transmitted out instead of being transmitted by the first antenna 112 through the signal transmitting/receiving unit 130. FIG. 6 illustrates the way in which the electronic device depicted in FIG. 3 transmits and receives wireless signals. When the electronic device 50 is held in the cavity 122 of the second casing 120 and is adjacent to the signal transmitting/receiving unit 130, as shown in FIG. 3, the electronic device 50 receives and transmits the signals in the way shown in FIG. 6, for instance. According to the way to receive and transmit the signals, as shown in FIG. 6, the wireless signal S3 from the surroundings is received by the first antenna 112 and arrives at the signal transmitting/receiving unit 130, and the signal transmitting/receiving unit 130 transmits the wireless signal S3 to the electronic device 50. In addition, the wireless signal S4 from the electronic device 50 is received by the signal transmitting/receiving unit 130 and transmitted to the first antenna 112, and the wireless signal S4 is transmitted out by the first antenna 112.

With reference to FIG. 2 and FIG. 3, the signal transmitting/receiving unit 130 described in the present embodiment is electrically connected to the first antenna 112 of the first casing 110 through the signal line 140, for instance. The wireless signal from the surroundings is received by the first antenna 112 and then transmitted to the signal transmitting/receiving unit 130 through the signal line 140, and the wireless signal from the electronic device 50 is received by the signal transmitting/receiving unit 130 and then transmitted to the first antenna 112 through the signal line 140.

In the present embodiment, the docking station 100 includes a display screen 150 and a keyboard 160. The display screen 150 is disposed at the first casing 110, and the keyboard 160 is disposed at the second casing 120. When the electronic device 50 is configured at the docking station 100, as shown in FIG. 3, the user is able to operate the electronic device 50 by means of the keyboard 160 located at the docking station 100 and observe the information displayed on the electronic device 50 through the display screen 150 located at the docking station 100. The electronic device 50 is connected to the keyboard 160 in a wireless manner, through a connector, or in any other appropriate manner, for instance, which should however not be construed as a limitation to the invention. Besides, the way to connect the electronic device 50 and the display screen 150 is not limited in the invention, and the electronic device 50 may be connected to the display screen 150 through a connector or in any other appropriate manner.

According to the present embodiment, the docking station 100 further includes a hinge 170, and the first casing 110 is pivoted to the second casing 120 through the hinge 170, for instance. Thereby, the first casing 110 and the second casing 120 may be unfolded (as shown in FIG. 1), and the first casing 110 may also be rotated with respect to the second casing 120 through the hinge 170, so that the first casing 110 and the second casing 120 may be folded. Thereby, the user is able to carry or pack up the docking station 100.

The signal transmitting/receiving unit 130 described in the present embodiment is a metal sheet, for instance, and the metal sheet is shaped as an antenna, such that the metal sheet is adapted for receiving and transmitting wireless signals corresponding to certain bandwidths of the first and second antennas 112 and 52. However, the invention is not limited thereto; in another embodiment, the signal transmitting/receiving unit 130 may be a circuit board that has a metal layer, and the metal layer is shaped as an antenna, such that the metal layer is adapted for receiving and transmitting wireless signals corresponding to certain bandwidths of the first and second antennas 112 and 52.

As shown in FIG. 4, the signal transmitting/receiving unit 130 described in the present embodiment is exposed by the second casing 120 to the bottom of the cavity 122. However, the invention is not limited thereto, and examples will be given hereinafter with reference to the drawings. FIG. 7 is a partial cross-sectional diagram illustrating a docking station and an electronic device according to another embodiment of the invention. Similar to the cavity 122 and the electronic device 50 shown in FIG. 4, the cavity 222 shown in FIG. 7 is adapted to hold the electronic device 50′. The difference between the embodiment shown in FIG. 7 and the embodiment shown in FIG. 4 lies in that the signal transmitting/receiving unit 230 shown in FIG. 7 is covered by the second casing 222 and hidden at the bottom of the cavity 222, so as to prevent the signal transmitting/receiving unit 230 from being contaminated by external liquid or dust or damaged by external forces.

FIG. 8 is a schematic diagram illustrating a signal booster between the first antenna and the signal transmitting/receiving unit depicted in FIG. 1. In the embodiment shown in FIG. 1, the wireless signals are transmitted to the signal transmitting/receiving unit 130 by the first antenna 112 and then transmitted to the second antenna 52 of the electronic device 50 through coupling, which may lead to degradations of the wireless signals; thereby, the signal receiving and transmitting capabilities of the electronic device 50 combined with the docking station 100 may not be maintained or improved. In response to said issue and in order to comply with the requirement for product design, a signal booster 180 may be additionally configured on a connection path between the first antenna 112 and the signal transmitting/receiving unit 130 in the docking station 100 (shown in FIG. 1), as illustrated in FIG. 8. The signal booster 180 may be connected to the first antenna 112 and the signal transmitting/receiving unit 130 through the signal line 140. After the first antenna 112 receives the external wireless signal, such a wireless signal may be boosted by the signal booster 180 and may then be transmitted to the signal transmitting/receiving unit 130; through coupling, the boosted wireless signal is then transmitted to the second antenna 52 of the electronic device 50, such that the received wireless signal strength may be enhanced after the electronic device and the docking station are combined.

To sum up, the docking station described herein has the signal transmitting/receiving unit at the bottom of the cavity of the second casing, and the first casing of the docking station has the first antenna. The signal transmitting/receiving unit is electrically connected to the first antenna. Accordingly, if the user places the electronic device in the cavity of the second casing, the signal transmitting/receiving unit at the bottom of the cavity is adjacent to the electronic device, such that the electronic device is capable of receiving and transmitting the wireless signals by the first antenna of the docking station through the signal transmitting/receiving unit. As a result, the signal receiving and transmitting capabilities of the electronic device may be improved.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A docking station comprising:
a first casing having a first antenna;
a second casing connected to the first casing, the second casing having a cavity, the cavity being adapted to hold an electronic device; and
a signal transmitting/receiving unit disposed at a bottom of the cavity and electrically connected to the first antenna, wherein when the electronic device is held in the cavity, the electronic device receives and transmits wireless signals by the first antenna through the signal transmitting/receiving unit.

2. The docking station as recited in claim 1, further comprising a display screen and a keyboard, wherein the display screen is disposed at the first casing, and the keyboard is disposed at the second casing.

3. The docking station as recited in claim 1, further comprising a hinge, wherein the first casing is pivoted to the second casing through the hinge.

4. The docking station as recited in claim 1, wherein the signal transmitting/receiving unit is a metal sheet shaped as an antenna.

5. The docking station as recited in claim 1, wherein the signal transmitting/receiving unit is a circuit board, and the circuit board has a metal layer shaped as an antenna.

6. The docking station as recited in claim 1, wherein the signal transmitting/receiving unit is covered by the second casing.

7. The docking station as recited in claim 1, wherein the signal transmitting/receiving unit is exposed by the second casing.

8. The docking station as recited in claim 1, wherein the signal transmitting/receiving unit is electrically connected to the first antenna through a signal line.

9. The docking station as recited in claim 1, comprising a signal booster located between the signal transmitting/receiving unit and the first antenna and connected to the signal transmitting/receiving unit and the first antenna through a signal line.

10. The docking station as recited in claim 1, wherein the electronic device has a second antenna, and when the electronic device is held in the cavity, the signal transmitting/receiving unit and the second antenna are coupled to each other.
